(19) United States
(12) Patent Application Publication
(10) Pub. No.: US 2026/0001803 A1
(43) Pub. Date: Jan. 1, 2026

(54) GLASS ARTICLE AND DISPLAY DEVICE COMPRISING THE SAME

(71) Applicant: Samsung Display Co., Ltd., Yongin-Si (KR)

(72) Inventors: Hyun Seung SEO, Yongin-si (KR); Mi Jin KIM, Yongin-si (KR); Tae Ho AN, Yongin-si (KR); Sook Kyung YOU, Yongin-si (KR); Jeong Seok LEE, Yongin-si (KR); Jun Ho Lee, Yongin-si (KR); Hyun Il CHO, Yongin-si (KR)

(21) Appl. No.: 19/074,436

(22) Filed: Mar. 10, 2025

(30) Foreign Application Priority Data
Jun. 26, 2024 (KR) 10-2024-0083762

(51) Int. Cl. C03C 10/00

(52) U.S. Cl. CPC C03C 10/00; C03C 2214/20

(57) ABSTRACT

A glass article comprises an amorphous glass layer having an amorphous phase, and crystal particles dispersed in the amorphous glass layer and having a crystalline phase, wherein some of the crystal particles protrude from a surface of the amorphous glass layer.

### CROSS-REFERENCE TO RELATED APPLICATION

This application claims priority from Korean Patent Application No. 10-2024-0083762 filed on Jun. 26, 2024, in the Korean Intellectual Property Office, and all the benefits accruing therefrom under 35 U.S.C. 119, the contents of which in its entirety are incorporated herein by reference.

### BACKGROUND

### 1. Field

The present disclosure relates to a glass article and a display device comprising the same.

### 2. Description of the Related Art

Glass articles are widely used in electronic devices including display devices, building materials, and the like. For example, a glass article is applied to a substrate of a flat panel display device, such as a liquid crystal display device (LCD), an organic light emitting display device (OLED) or an electrophoretic display device, or to a cover window for protecting the display device.

As use of portable electronic devices such as smart phones and tablet PCs increases, glass articles applied to the portable electronic devices are more frequently exposed to external impacts. It is desirable to have glass articles that are thin for portability and that can withstand external impacts.

Recently, display devices that can be folded for user convenience have been developed. A desirable glass article to be applied to a foldable display device would have a thin thickness to relieve bending stress when folded and at the same time would have sufficient strength to withstand external impacts.

### SUMMARY

The present disclosure may provide a glass article with improved hardness, anti-reflection and anti-glare properties and a display device including the glass article.

An embodiment of an electronic device comprises an amorphous glass layer having an amorphous phase, and crystal particles dispersed in the amorphous glass layer and having a crystalline phase, wherein some of the crystal particles protrude from a surface of the amorphous glass layer.

In an embodiment, the amorphous glass layer includes an upper surface, a lower surface facing the upper surface and a side surface connecting the upper surface and the lower surface, and the some of the crystal particles protrude from at least one of the upper surface, the lower surface, and the side surface of the amorphous glass layer.

In an embodiment, the some of the crystal particles protrude from the upper surface and the side surface of the amorphous glass layer.

In an embodiment, the some of the crystal particles protrude from the upper surface of the amorphous glass layer.

In an embodiment, the some of the crystal particles do not protrude from the lower surface of the amorphous glass layer.

In an embodiment, the upper surface of the amorphous glass layer includes a first area and a second area surrounding the first area in a plan view, and the some of the crystal particles protrude from the upper surface of the amorphous glass layer in the first area and not protrude from the upper surface of the amorphous glass layer in the second area.

In an embodiment, a thickness of the first area of the amorphous glass layer is smaller than the thickness of the second area of the amorphous glass layer.

In an embodiment, the upper surface of the amorphous glass layer includes a first area and a second area surrounding the first area, and the some of the crystal particles protrude from the upper surface of the amorphous glass layer in the first area and in the second area.

In an embodiment, a thickness of the first area of the amorphous glass layer is greater than the thickness of the second area of the amorphous glass layer.

In an embodiment, a size of the crystal particle is 10 nm to 50 nm.

In an embodiment, a crystallinity is 50% to 85%.

In an embodiment, a height of the crystal particle protruding from the surface of the amorphous glass layer is 10 nm to 50 nm.

An embodiment of a glass article comprises an amorphous glass layer having an amorphous phase, and crystal particles dispersed in the amorphous glass layer and having a crystalline phase, wherein the amorphous glass layer comprises one surface including a first area and a second area surrounding the first area in a plan view, and some of the crystal particles protrude from the surface of the amorphous glass layer in the first area.

In an embodiment, a thickness of the first area of the amorphous glass layer is smaller than the thickness of the second area of the amorphous glass layer.

In an embodiment, the some of the some of the crystal particles protrude from the surface of the amorphous glass layer in the first area and the second area.

In an embodiment, the thickness of the first area of the amorphous glass layer is greater than the thickness of the second area of the amorphous glass layer.

In an embodiment, a size of the crystal particle is 10 nm to 50 nm.

In an embodiment, a crystallinity is 50% to 85%.

In an embodiment, a height of the crystal particle protruding from the surface of the amorphous glass layer is 10 nm to 50 nm.

An embodiment of a glass article comprises a display panel, and a cover window disposed on the display panel, wherein the cover window comprises an amorphous glass layer having an amorphous phase, and crystal particles dispersed in the amorphous glass layer and having a crystalline phase, wherein some of the crystal particles protrude from a surface of the amorphous glass layer.

A glass article according to an embodiment may be formed so that crystal particles protrude from a surface of an amorphous glass layer improving hardness of the glass article reducing reflectance of light incident from the outside.

Accordingly, the display device including a glass article as a cover window may provide a high-quality display device by improving durability and reducing reflectance of light incident from the outside.

However, the effects of the present disclosure are not restricted to the one set forth herein. The above and other effects of the present disclosure will become more apparent to one of ordinary skill in the art to which the present disclosure pertains by referencing the detailed description and the claims.

### BRIEF DESCRIPTION OF THE DRAWINGS

These and other aspects will become apparent and more readily appreciated from the following description of the embodiments, taken in conjunction with the accompanying drawings in which:

FIG. 1 is a perspective view of glass articles according to embodiments;

FIG. 2 is a perspective view illustrating an unfolded state of a display device to which a glass article according to an embodiment is applied;

FIG. 3 is a perspective view illustrating a folded state of the display device of FIG. 2;

FIG. 4 is a cross-sectional view illustrating an example in which a glass article according to an embodiment is applied as a cover window of a display device;

FIG. 5 is a cross-sectional view of a glass article according to an embodiment;

FIG. 6 is a cross-sectional view of a glass article according to an embodiment;

FIG. 7 is a plan view of a glass article according to an embodiment;

FIG. 8 is a cross-sectional view illustrating an example of a glass article cut along line XI-XI′ of FIG. 7;

FIG. 9 is a cross-sectional view illustrating another example of a glass article cut along line XI-XI′ of FIG. 7;

FIG. 10 is a flowchart illustrating a method of manufacturing a glass article according to an embodiment;

FIGS. 11, 12, 13, 14, and 15 are cross-sectional views illustrating a method of manufacturing a glass article according to an embodiments;

FIG. 16 is a cross-sectional view illustrating a method of manufacturing a glass article according to an embodiment;

FIG. 17 is an image illustrating a glass article manufactured according to Example 1;

FIG. 18 is an image illustrating a glass article manufactured according to Example 2; and

FIG. 19 is an SEM image illustrating a glass article manufactured according to Example 1.

### DETAILED DESCRIPTION OF THE EMBODIMENTS

Embodiments will now be described more fully hereinafter with reference to the accompanying drawings. The present disclosure, however, should not be construed as limited to the embodiments set forth herein. Rather, these embodiments are provided so that the disclosure will be thorough and complete, and will convey its scope to those of ordinary skill in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, embodiments will be described with reference to the accompanying drawings.

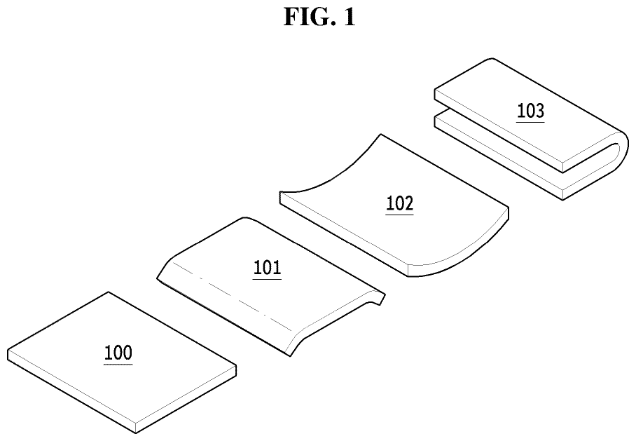

FIG. 1 is a perspective view of glass articles according to various embodiments.

Glass is used as a cover window for protecting a display device, a substrate for a display device panel, a substrate for a touch panel, an optical member such as a light guide plate, etc. in electronic devices including display devices such as tablet PCs, notebook PCs, smartphones, electronic books, televisions and PC monitors as well as refrigerators and washing machines including display screens. The glass may also be used for cover glass of vehicle dashboards, cover glass of solar cells, building interior materials, and windows of buildings or houses.

It is desirable that glass have great strength. For example, glass for windows should be thin, have high transmittance and be light weight but should be strong enough to not be easily broken by an external impact. Glass with increased strength may be produced using a method such as chemical tempering or thermal tempering. Examples of tempered glass having various shapes are illustrated in FIG. 1.

Referring to FIG. 1, in an embodiment, a glass article 100 may be in the shape of a flat sheet or a flat plate. In other embodiments, glass articles 101 through 103 may have a three-dimensional (3D) shape including a bent portion. For example, a glass article may have edges of a flat portion bent (see ‘101’), may be generally curved (see ‘102’), or may be folded (see ‘103’). Alternatively, the glass article 100 may be shaped like a flat sheet or a flat plate but may have flexibility so that it may be a foldable glass article that may be folded or bent. In addition, the glass article 100 may be stretched or rolled.

The glass articles 100 through 103 may have a rectangular planar shape. However, the glass articles 100 through 103 are not limited to the rectangular planar shape and may also have various planar shapes such as a rectangle with rounded corners, a square, a circle, and an oval. In the following embodiments, a flat plate having a rectangular planar shape will be described as an example of the glass articles 100 through 103. However, the present disclosure is not limited thereto.

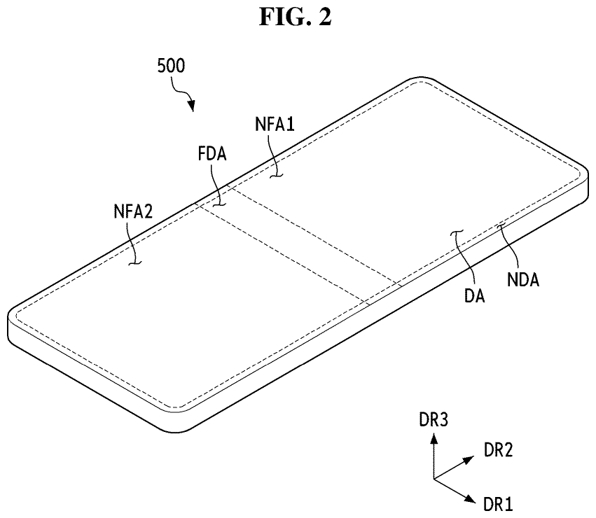

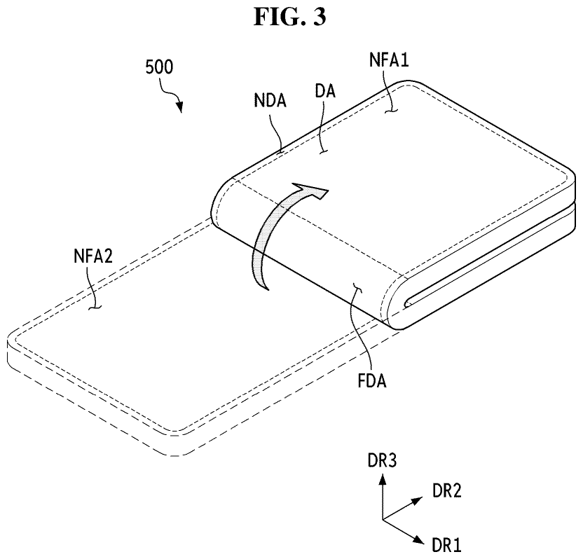

FIG. 2 is a perspective view illustrating an unfolded state of a display device to which a glass article according to an embodiment is applied. FIG. 3 is a perspective view illustrating a folded state of the display device of FIG. 2.

Referring to FIGS. 2 and 3, a display device 500 according to the embodiment may be a foldable display device. As will be described later, the glass article 100 of FIG. 1 may be applied to the display device 500 as a cover window. The glass article 100 may have flexibility so that it can be folded.

In FIGS. 2 and 3, a first direction DR1 may be a direction parallel to a side of the display device 500 in a plan view, for example, a horizontal direction of the display device 500. A second direction DR2 may be a direction parallel to another side of the display device 500 in contact with the above side in a plan view, for example, a vertical direction of the display device 500. A third direction DR3 may be a thickness direction of the display device 500.

In an embodiment, the display device 500 may be rectangular in a plan view. The display device 500 may be shaped like a rectangle with perpendicular corners or a rectangle with rounded corners in a plan view. The display device 500 may include two short sides disposed in the first direction DR1 and two long sides disposed in the second direction DR2 in a plan view.

The display device 500 includes a display area DA and a non-display area NDA. The shape of the display area DA may correspond to the shape of the display device 500 in a plan view. For example, when the display device 500 is rectangular in a plan view, the display area DA may also be rectangular.

The display area DA may include a plurality of pixels to display an image. The pixels may be arranged in a matrix direction. Each of the pixels may be shaped like a rectangle, a rhombus, or a square in a plan view. However, the present disclosure is not limited thereto. For example, each of the pixels may also be shaped like a quadrilateral other than a rectangle, a rhombus or a square, a circle, or an oval in a plan view.

The non-display area NDA may not display an image because it does not include pixels. The non-display area NDA may be disposed around the display area DA. The non-display area NDA may surround the display area DA. However, the present disclosure is not limited thereto. The display area DA may also be partially surrounded by the non-display area NDA.

In an embodiment, the display device 500 may maintain both the folded state and the unfolded state. The display device 500 may be folded in an in-folding manner in which the display area DA is disposed inside as illustrated in FIG. 3. When the display device 500 is folded in the in-folding manner, portions of an upper surface of the display device 500 may face each other. Alternatively, the display device 500 may be folded in an out-folding manner in which the display area DA is disposed outside. When the display device 500 is folded in the out-folding manner, portions of a lower surface of the display device 500 may face each other.

In an embodiment, the display device 500 may be a foldable device. In the present specification, the term “foldable device” is used to refer to devices that can be folded, including not only a folded device but also a device that can have both the folded state and the unfolded state. In addition, folding typically includes folding at an angle of about 180 degrees. However, the present disclosure is not limited thereto, and folding at an angle of more than or less than 180 degrees, such as folding at an angle of 90 to less than 180 degrees or an angle of 120 to less than 180 degrees may also be understood as folding. Furthermore, even an incompletely folded state may also be referred to as the folded state if it is not the unfolded state. For example, even a folded state at an angle of 90 degrees or less may be expressed as the folded state to distinguish it from the unfolded state as long as a maximum folding angle is 90 degrees or more. The radius of curvature at the time of folding may be 5 mm or less, preferably, 1 to 2 mm or about 1.5 mm. However, the present disclosure is not limited thereto.

In an embodiment, the display device 500 may include a folding area FDA, a first non-folding area NFA1, and a second non-folding area NFA2. The folding area FDA may be an area in which the display device 500 is folded, and the first non-folding area NFA1 and the second non-folding area NFA2 may be areas in which the display device 500 is not folded.

The first non-folding area NFA1 may be disposed on a side, e.g., an upper side of the folding area FDA. The second non-folding area NFA2 may be disposed on the other side, e.g., a lower side of the folding area FDA. The folding area FDA may be an area bent with a predetermined curvature.

In an embodiment, the folding area FDA of the display device 500 may be set at a specific position. In the display device 500, one folding area FDA or two or more folding areas FDA may be set at a specific position. In an embodiment, the folding area FDA may not be limited to a specific position in the display device 500 but may be freely set in various areas.

In an embodiment, the display device 500 may be folded in the second direction DR2. As a result, a length of the display device 500 in the second direction DR2 may be reduced to about half. Therefore, a user can easily carry the display device 500.

In an embodiment, the direction in which the display device 500 is folded is not limited to the second direction DR2. For example, the display device 500 may also be folded in the first direction DR1. In this case, the length of the display device 500 in the first direction DR1 may be reduced to about half.

In the drawings, each of the display area DA and the non-display area NDA overlaps the folding area FDA, the first non-folding area NFA1, and the second non-folding area NFA2. However, the present disclosure is not limited thereto. For example, each of the display area DA and the non-display area NDA may overlap at least one of the folding area FDA, the first non-folding area NFA1, and the second non-folding area NFA2.

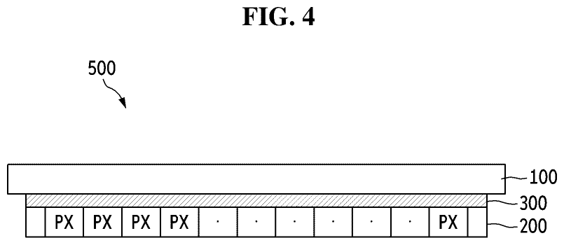

FIG. 4 is a cross-sectional view illustrating an example in which a glass article according to an embodiment is applied as a cover window of a display device.

Referring to FIG. 4, the display device 500 may include a display panel 200, the glass article 100 disposed on the display panel 200 and serving as a cover window, and an optically clear bonding layer 300 disposed between the display panel 200 and the glass article 100 to bond the display panel 200 and the glass article 100 together.

The display panel 200 may be, for example, a self-luminous display panel such as an organic light emitting display panel (OLED), an inorganic electroluminescent (EL) display panel, a quantum dot light emitting display panel (QED), a micro-light emitting diode (LED) display panel, a nano-LED display panel, a plasma display panel (PDP), a field emission display panel (FED) or a cathode ray tube (CRT) display panel or may be a light receiving display panel such as a liquid crystal display (LCD) panel or an electrophoretic display (EPD) panel.

The display panel 200 may include a plurality of pixels PX and may display an image using light emitted from each pixel PX. The display device 500 may further include a touch member (not illustrated). In an embodiment, the touch member may be internalized in the display panel 200. For example, the touch member may be directly formed on a display member of the display panel 200 so that the display panel 200 itself can perform a touch function. In an embodiment, the touch member may be manufactured separately from the display panel 200 and then attached to an upper surface of the display panel 200 by an optically clear bonding layer.

The glass article 100 is disposed on the display panel 200 to protect the display panel 200. The glass article 100 may be larger in size than the display panel 200. Thus, side surfaces of the glass article 100 may protrude outward from side surfaces of the display panel 200, but the present disclosure is not limited to this case. The display device 500 may further include a printed layer (not illustrated) disposed on at least one surface of the glass article 100 in an edge portion of the glass article 100. The printed layer may prevent a bezel area of the display device 500 from being visible from the outside and, in some cases, may perform a decorative function.

The optically clear bonding layer 300 is disposed between the display panel 200 and the glass article 100. The optically clear bonding layer 300 fixes the glass article 100 on the display panel 200. The optically clear bonding layer 300 may include an optical clear adhesive (OCA) or an optical clear resin (OCR).

The glass article 100 described above will now be described in more detail.

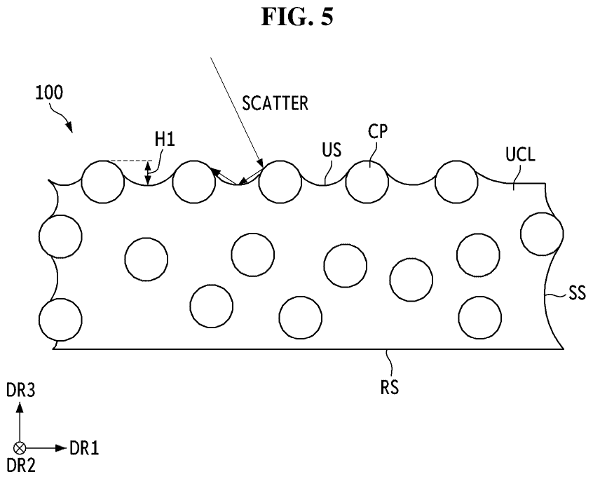

FIG. 5 is a cross-sectional view of a glass article according to an embodiment.

Referring to FIG. 5, a glass article 100 according to an embodiment may be a crystallized glass (glass-ceramics). The crystallized glass is known to have superior electrical, mechanical, thermal, physical, and chemical properties compared to a mother glass (e.g., non-crystallized glass). Crystallized glass may be manufactured by heat treating the mother glass, as will be described later, and has the advantage of improving mechanical properties and controlling the thermal expansion coefficient by adjusting the size of crystal particles according to the heat treatment method.

The glass article 100 may include lithium alumino silicate (LAS)-based crystallized glass or sodium alumino silicate (SAS)-based crystallized glass. In an embodiment, the glass article 100 may include the lithium alumino silicate (LAS)-based crystallized glass. For example, the glass article 100 may include silicon dioxide (SiO₂), aluminum oxide (Al₂O₃), and lithium oxide (LiO₂). In this case, the glass article 100 may further include one selected from phosphorus pentoxide (P₂O₅), potassium oxide (K₂O), magnesium oxide (MgO), calcium oxide (CaO), strontium oxide (SrO), barium oxide (BaO), tin oxide (SnO₂) and zirconium oxide (ZrO₂). However, the present disclosure is not limited thereto, and the glass article 100 may further include other ingredients.

In other embodiment, the glass article 100 may include silicon dioxide (SiO₂), aluminum oxide (Al₂O₃), lithium oxide (LiO₂), and sodium oxide (Na₂O). In this case, the glass article 100 may further include one selected from phosphorus pentoxide (P₂O₅), potassium oxide (K₂O), magnesium oxide (MgO), calcium oxide (CaO), strontium oxide (SrO), barium oxide (BaO), tin oxide (SnO₂) and zirconium oxide (ZrO₂). However, the present disclosure is not limited thereto, and the glass article 100 may further include other ingredients.

The glass article 100 according to an embodiment may include an amorphous glass layer UCL and a plurality of crystal particles CP dispersed in the amorphous glass layer UCL.

The amorphous glass layer UCL may be made of an amorphous phase in the glass article 100. The amorphous glass layer UCL may form the overall appearance of the glass article 100.

The plurality of crystal particles CP may be formed by crystallizing glass to form a crystal phase. The plurality of crystal particles CP may be disposed to randomly disperse in the amorphous glass layer UCL. For example, each gap between the plurality of crystal particles CP may be random. The size of the plurality of crystal particles CP may be 10 nm to 50 nm. Here, when the size of the plurality of crystal particles CP is 10 nm or more, the hardness of the glass article 100 may be increased, and when the size of the plurality of crystal particles CP is 50 nm or less, a decrease of transmittance of the glass article 100 may be prevented.

The crystallinity of the glass article 100 may be 50% to 85%. Here, the crystallinity of the glass article 100 may be the ratio, for example, the volume ratio, of the crystal particles CP within the glass article 100. When the crystallinity of the glass article 100 is 50% or more, the hardness of the glass article 100 may be increased, and when the crystallinity of the glass article 100 is 85% or less, a decrease of the transmittance of the glass article 100 may be prevented.

In the glass article 100 according to an embodiment, the plurality of crystal particles CP may protrude from a surface of the amorphous glass layer UCL. For example, the plurality of crystal particles CP may be formed in a shape protruding outside on at least one surface of the glass article 100.

As illustrated in FIG. 5, the amorphous glass layer UCL of the glass article 100 may include an upper surface US which a user faces, a lower surface RS facing the display panel 200 (see FIG. 4), and a side surface SS connecting the upper surface US and the lower surface RS.

According to an embodiment, the plurality of crystal particles CP may protrude from a surface (e.g., upper surface US and side surface SS) of the amorphous glass layer UCL in the upper surface US and side surface SS of the amorphous glass layer UCL. When the plurality of crystal particles CP have a structure that protrudes above the surface of the amorphous glass layer UCL, light incident from the outside may be reflected and scattered on the surfaces of the plurality of crystal particles CP. Particularly, the refractive index of the plurality of crystal particles CP may be about 1.54 to 1.55, and the refractive index of the amorphous glass layer UCL may be about 1.51 to 1.52, and the refractive index of the plurality of crystal particles CP may be greater than the refractive index of the amorphous glass layer UCL. Light incident from the outside may be reflected and scattered at the interface between the plurality of high-refractive crystal particles CP and the relatively low-refractive amorphous glass layer UCL. Accordingly, reflection of light incident from the outside on the surface of the glass article 100 may be reduced to achieve anti-reflection and anti-glare effects.

A height H1 of the plurality of crystal particles CP protruding from the surface of the amorphous glass layer UCL may be 10 nm to 50 nm. The height H1 of the plurality of crystal particles CP protruding from the surface of the amorphous glass layer UCL may be similar to the size of the plurality of crystal particles CP. Although FIG. 5 illustrates that the spacing between the plurality of crystal particles CP protruding from the surface of the amorphous glass layer UCL is uniform, the spacing between the plurality of crystal particles CP may be substantially random. In addition, although the height H1 of the plurality of crystal particles CP protruding from the surface of the amorphous glass layer UCL is illustrated to be similar, the height H1 of the plurality of crystal particles CP protruding from the surface of the amorphous glass layer UCL may be substantially random.

Further, the plurality of crystal particles CP protruding from the surface of the amorphous glass layer UCL may have a higher hardness than the amorphous glass layer UCL. That is, the plurality of crystal particles CP may have high hardness. As the plurality of crystal particles CP having high hardness protrudes from the upper surface US and the side surface SS of the glass article 100, the hardness of the upper surface US and the side surface SS of the glass article 100 may be improved. In addition, as the plurality of crystal particles CP are randomly disposed in the amorphous glass layer UCL, the overall hardness of the glass article 100 may be improved.

The lower surface RS of the amorphous glass layer UCL may be formed to be flat. The plurality of crystal particles CP may not protrude from the lower surface RS of the amorphous glass layer UCL. The lower surface RS of the amorphous glass layer UCL may be covered by a protective film PTF and not be etched in an etching process to be described later.

As described above, as the plurality of crystal particles CP is disposed to protrude from at least one surface of the amorphous glass layer UCL in the glass article 100 according to an embodiment, light incident from the outside may be reduced to achieve anti-reflection and anti-glare effects. In addition, the hardness of the surface of the glass article 100 may be improved.

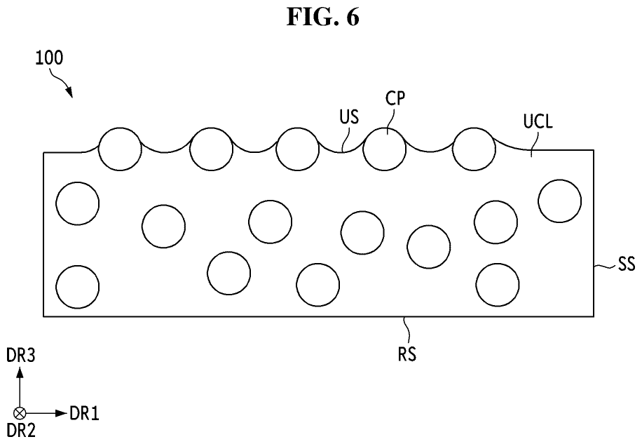

FIG. 6 is a cross-sectional view of a glass article according to an embodiment.

Referring to FIG. 6, the glass article 100 of the present embodiment is different from the embodiment of FIG. 5 in that the plurality of crystal particles CP only protrudes from the upper surface UP of the amorphous glass layer UCL. Hereinafter, a description of contents overlapping those of the above-described embodiment will be omitted, and contents different from those of the above-described embodiment will be described.

The plurality of crystal particles CP may be disposed to protrude from the upper surface US of the amorphous glass layer UCL. On the other hand, the plurality of crystal particles CP may not protrude from the side surface SS of the amorphous glass layer UCL and be formed flat. Only the amorphous glass layer UCL may be exposed in the side surface SS of the amorphous glass layer UCL, and the plurality of crystal particles CP may not protrude. The side surface SS of the amorphous glass layer UCL may be covered by the protective film PTF and not be etched in an etching process to be described later.

The upper surface US of the amorphous glass layer UCL may form the upper surface of the glass article 100 and may be a surface on which a screen is displayed outside of the display device and is touched by a user. The side surface SS of the amorphous glass layer UCL may be an area covered with a frame of the display device. That is, the upper surface (e.g., the upper surface US of the amorphous glass layer UCL) of the glass article 100 is required of anti-reflection and anti-glare effects and is required of high hardness characteristics. In the present embodiment, as the plurality of crystal particles CP with high refraction and high hardness is disposed to protrude from the upper surface US of the glass article 100, anti-reflection and anti-glare effects may be achieved, and surface hardness may also be improved.

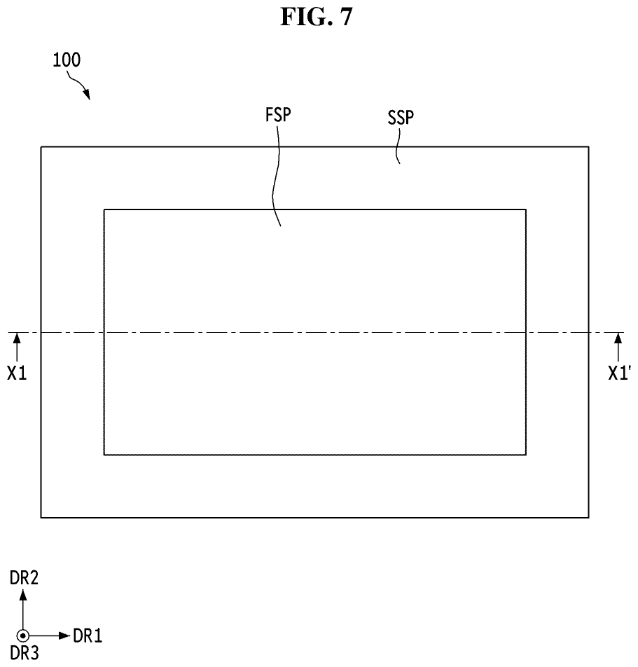

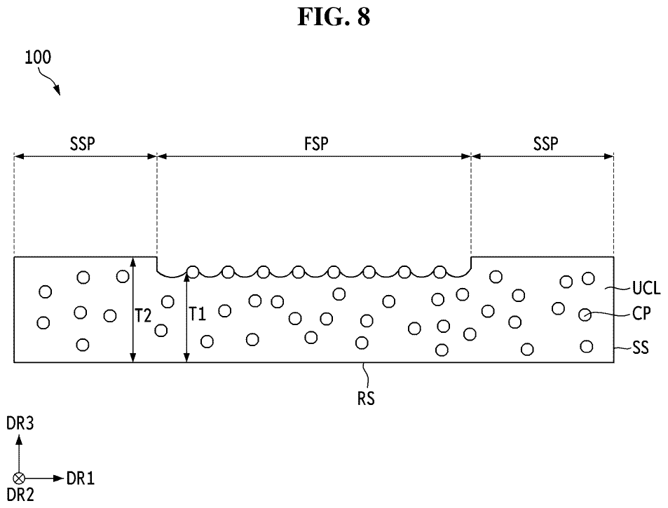

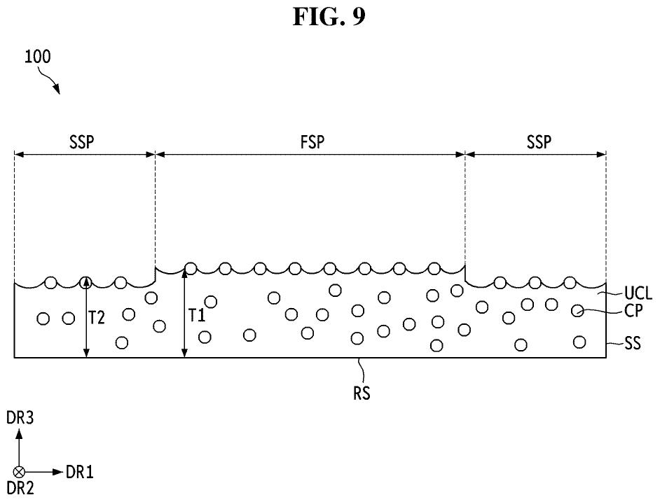

FIG. 7 is a plan view of a glass article according to an embodiment. FIG. 8 is a cross-sectional view illustrating an example of a glass article cut along line XI-XI′ of FIG. 7. FIG. 9 is a cross-sectional view illustrating another example of a glass article cut along line XI-XI′ of FIG. 7.

Referring to FIG. 8 in conjunction with FIG. 7, in the glass article 100 according to an embodiment, the upper surface US of the amorphous glass layer UCL may include a first area FSP and a second area SSP. The first area FSP may be an area including a central portion of the upper surface US and may be an area correspondingly overlapping the display area DA (see FIG. 2) of the display device 500 (see FIG. 2). The second area SSP may be an area including the edge of the upper surface US and may be an area correspondingly overlapping the non-display area NDA (see FIG. 2). The second area SSP may be disposed to surround the first area FSP in plan view.

In the first area FSP of the upper surface US of the amorphous glass layer UCL, the plurality of crystal particles CP may protrude above the surface of the amorphous glass layer UCL. The second area SSP of the upper surface US of the amorphous glass layer UCL may be disposed to surround the first area FSP, and the plurality of crystal particles CP may not protrude above the surface of the amorphous glass layer UCL. The first area FSP of the upper surface US of the amorphous glass layer UCL may form an uneven surface due to the plurality of protruding crystal particles CP, and the second area SSP of the upper surface US of the amorphous glass layer UCL may form a flat surface.

A thickness T1 of the first area FSP may be smaller than a thickness T2 of the second area SSP. Here, the thickness may mean the maximum distance measured in the third direction DR3 from the lower surface RS of the amorphous glass layer UCL. The first area FSP may be an area in which the amorphous glass layer UCL is etched and partially removed in an etching process to be described later, and the second area SSP may be an area that is not etched. Accordingly, the thickness T1 of the first area FSP may be smaller than the thickness T2 of the second area SSP.

The first area FSP of the upper surface US of the amorphous glass layer UCL is the surface outside the display device on which the screen is displayed and the user touches, and is required to have anti-reflection and anti-glare effects and have high hardness characteristics. In the present embodiment, as the plurality of crystal particles CP with high-refractive and high hardness is disposed to protrude from the first area FSP of the upper surface US of the amorphous glass layer UCL, anti-reflection and anti-glare effects may be achieved, and surface hardness may also be improved. In addition, in the second area SSP of the upper surface US of the amorphous glass layer UCL on which no screen is displayed and no user touches, the plurality of crystal particles CP may be formed not to protrude.

Referring to FIG. 9, in the glass article 100 according to an embodiment, the plurality of crystal particles CP may be disposed to protrude in both of the first area FSP and the second area SSP of the upper surface US of the amorphous glass layer UCL. In this case, the thickness T1 of the first area FSP may be greater than the thickness T2 of the second area SSP. The thickness of the amorphous glass layer UCL may be formed by adjusting the etching process time to be described later. For example, when the entire glass article 100 is immersed in an etching solution and etched and then a protective film is attached to the first area FSP of the upper surface US of the amorphous glass layer UCL and etching is performed again, the second area SSP may be etched more. Accordingly, the thickness T1 of the first area FSP of the amorphous glass layer UCL may be formed to be greater than the thickness T2 of the second area SSP.

As will be described later, as the etching amount of the glass article 100 increases, the gloss unit of the amorphous glass layer UCL may decrease. For example, the etching amount of the first area FSP of the upper surface US of the amorphous glass layer UCL may be reduced since the area is where a screen is displayed, and the etching amount of the second area SSP may be increased since the area is required to be black without the screen displayed. That is, the gloss unit of the glass article 100 may be adjusted freely by forming the etching amount to be different for each area of the glass article 100.

Hereinafter, a method of manufacturing the glass article 100 described above will be described with reference to other drawings.

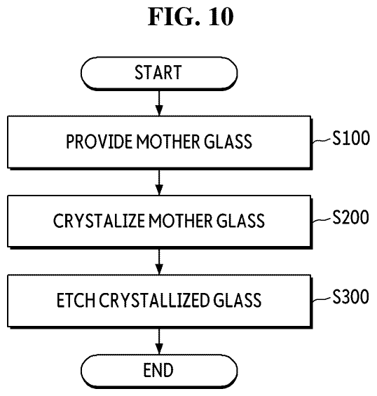

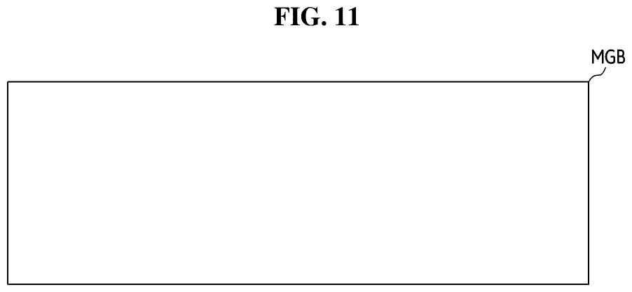

FIG. 10 is a flowchart illustrating a method of manufacturing a glass article according to an embodiment. FIGS. 11 to 15 are cross-sectional views illustrating a method of manufacturing a glass article according to an embodiment for each process. According to an embodiment, the method of manufacturing the glass article 100 described with reference to FIGS. 10 to 15 produces the glass article 100 illustrated in FIG. 5.

Referring to FIG. 10, the method of manufacturing a glass article according to an embodiment may include providing a mother glass (S100), crystallizing the mother glass (S200), and etching the crystallized glass (S300).

Referring to FIG. 11 in conjunction with FIG. 10, a mother glass MGB is provided first (S100). The mother glass MGB may include lithium alumino silicate (LAS)-based amorphous glass or sodium alumino silicate (SAS)-based amorphous glass. The lithium alumino silicate (LAS)-based amorphous glass may include silicon dioxide (SiO₂), aluminum oxide (Al₂O₃), and lithium oxide (LiO₂). In this case, the lithium alumino silicate (LAS)-based amorphous glass may further include one selected from phosphorus pentoxide (P₂O₅), potassium oxide (K₂O), magnesium oxide (MgO), calcium oxide (CaO), strontium oxide (SrO), barium oxide (BaO), tin oxide (SnO₂) and zirconium oxide (ZrO₂).

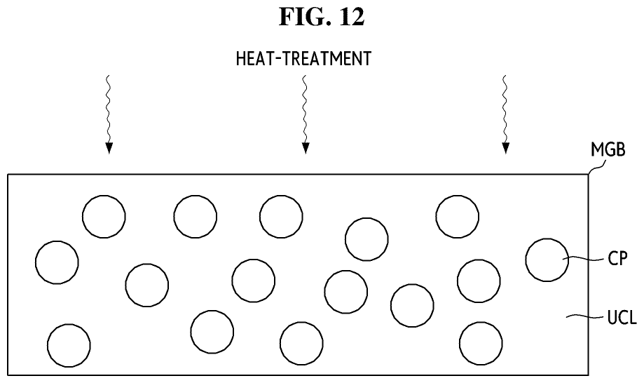

Next, referring to FIG. 12, the mother glass MGB is crystallized (S200). In the step of crystallizing the mother glass MGB, the crystallization may take place through heat-treatment or laser. In an embodiment, the mother glass MGB may be crystallized through a heat-treating process. For example, the mother glass MGB may be put in a furnace and heated to be crystallized. The heat-treating process may be performed by raising the temperature from room temperature to the first temperature and maintaining the temperature for a certain period of time, and then raising the temperature to the second temperature and maintaining the temperature for a certain period of time. For example, the raised temperature may range from about 5° C./min to 15° C./min, the first temperature may be about 500° C. to 600° C., and the second temperature may be about 700° C. to 800° C. The time maintained at the first temperature may be in the range of 3 to 5 hours, and the time maintained at the second temperature may be in the range of 1 to 3 hours. However, the present disclosure is not limited thereto.

In the heat-treating process, the amorphous mother glass MGB may be crystallized into crystalline. Specifically, when heat is applied to the mother glass MGB, some of the amorphous mother glass MGB may be crystallized to form crystalline crystal particles CP, and the remaining portion of the amorphous mother glass MGB may maintain the amorphous phase to form an amorphous glass layer UCL. At this time, the heat-treating process may be adjusted so that the size of each of the crystal particles CP is formed to be in a range of 10 nm to 50 nm and the crystallinity is formed to be in a range of 50% to 85%. Accordingly, the amorphous mother glass MGB may be formed into a crystallized glass CMB.

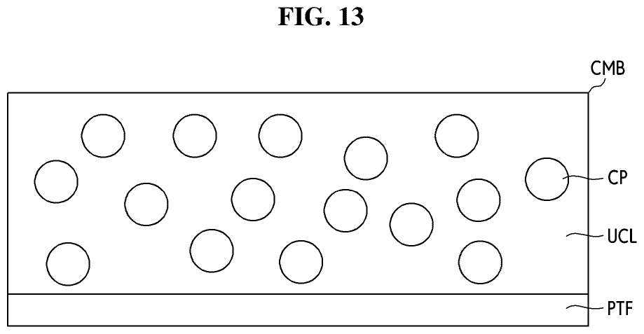

Next, referring to FIG. 13, a protective film PTF is attached to one surface of the crystallized glass CMB. One surface of the crystallized glass CMB to which the protective film PTF is attached may be the surface that faces the display panel later. The protective film PTF may serve to prevent the crystallized glass CMB from being etched in the etching process to be described later, and may be a polymer film such as PET.

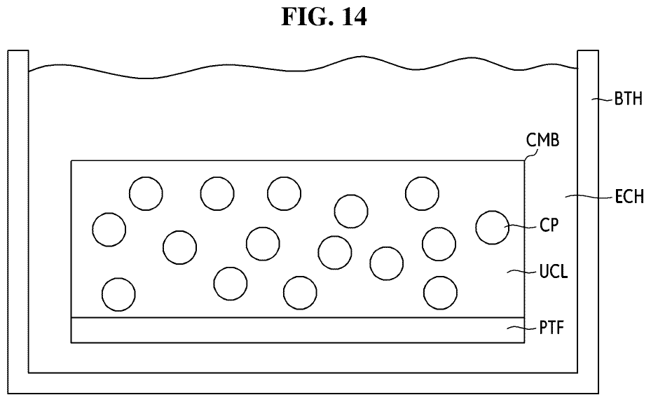

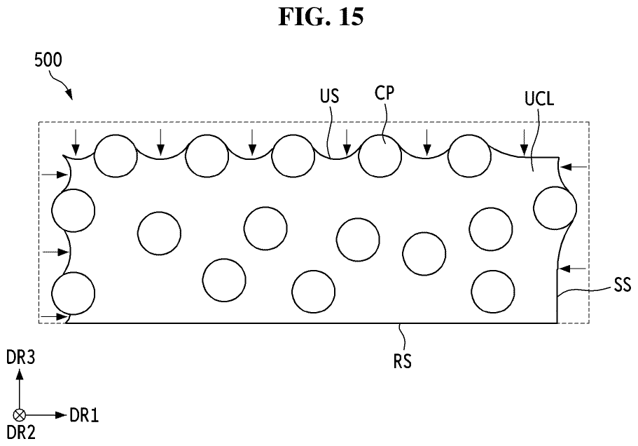

Subsequently, referring to FIGS. 14 and 15, the crystallized glass CMB is etched (S300). The etching process may be performed by immersing the crystallized glass CMB in a bath tank BTH filled with etching solution ECH. The etching solution ECH used in the etching process may be ammonium fluoride or hydrofluoric acid, but the present disclosure is not limited thereto. The etching may be performed during the etching time of 1 second to 60 minutes, and the etching time may be adjusted based on the etching amount of the crystallized glass CMB.

Additional cleaning processes may be performed before and after etching the crystallized glass CMB, respectively. For example, the cleaning process may be performed for 1 to 60 minutes using sodium hydroxide.

As illustrated in FIG. 15, when the crystallized glass CMB is immersed in the bath tank BTH filled with the etching solution ECH, the amorphous glass layer UCL may be etched with a high etching rate by the etching solution ECH. For example, the amorphous glass layer UCL may be etched in the upper surface US and the side surface SS of the crystallized glass CMB not covered by the protective film PTF and be removed. The amorphous glass layer UCL may be etched in the central direction, and the plurality of crystal particles CP disposed in the crystallized glass CMB may be exposed above the surface of the amorphous glass layer UCL and protrude.

By adjusting the etching time of the crystallized glass CMB, the degree to which the plurality of crystal particles CP protrude above the surface of the amorphous glass layer UCL may be determined. For example, the shorter the etching time, the smaller the degree to which the plurality of crystal particles CP protrude above the surface of the amorphous glass layer UCL.

Through the above-described process, a glass article may be manufactured in which the plurality of crystal particles CP protrude above the surface of the amorphous glass layer UCL.

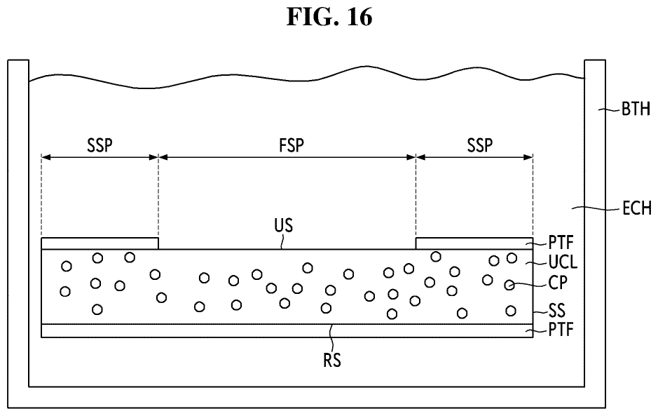

FIG. 16 is a cross-sectional view illustrating a method of manufacturing a glass article according to an embodiment.

Referring to FIG. 16, the first area FSP of the upper surface US of the crystallized glass CMB may be exposed and the protective film PTF may be attached to each of the second area SSP and the lower surface RS and be etched. In this case, the amorphous glass layer UCL of the first area FSP of the upper surface US of the crystallized glass CMB may be etched and removed, and the plurality of crystal particles CP may be exposed and formed to protrude from the surface of the amorphous glass layer UCL. The lower surface RS and the second area SSP of the upper surface US of the crystallized glass CMB may be protected by the etching solution ECH and not be etched.

Through such etching process of the crystallized glass CMB, the glass article 100 illustrated in FIG. 8 may be manufactured.

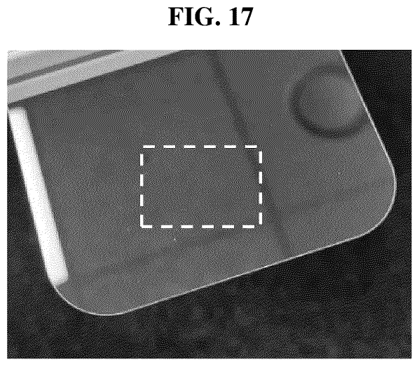

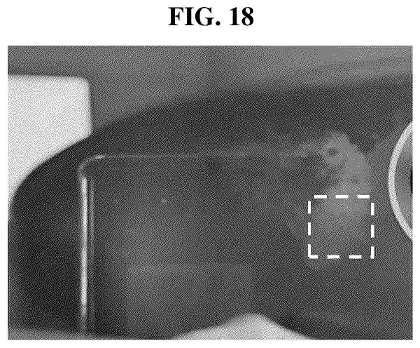

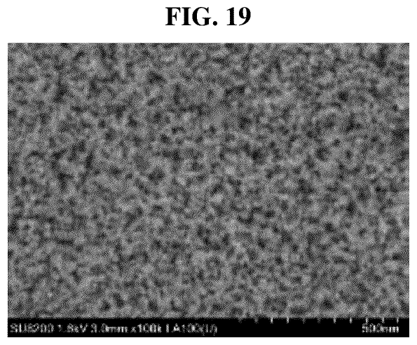

FIG. 17 is an image illustrating a glass article manufactured according to Example 1. FIG. 18 is an image illustrating a glass article manufactured according to Example 2. FIG. 19 is an SEM image illustrating a glass article manufactured according to Example 1.
Example 1 was manufactured by attaching a protective film to a certain area of the crystallized glass and performing first cleaning, etching, and second cleaning. The first and second cleaning was performed for about 30 minutes using sodium hydroxide, and the etching was performed by immersing in hydrofluoric acid for about 3 minutes. The glass article manufactured according to Example 1 was etched about 1 μm.
Example 2 was manufactured by attaching a protective film to a certain area of the crystallized glass and performing first cleaning, etching, and second cleaning. The first and second cleaning was performed for about 30 minutes using sodium hydroxide, and the etching was performed by immersing in ammonium fluoride for about 25 minutes. The glass article manufactured according to Example 2 was etched about 10 μm.

The surface gloss unit of the glass article manufactured according to the Examples 1 and 2 was measured. In addition, the areas where the protective film was not attached in the Examples 1 and 2 were marked with square boxes in FIGS. 17 and 18.

Referring to FIG. 17, the glass article manufactured according to Example 1 showed no visual difference between the area marked by the square box (the area where the protective film was not attached) and the peripheral area. In addition, the gloss unit (GU60°) was found to be 105.

Referring to FIG. 18, in the glass article manufactured according to Example 2, a difference from the peripheral area was observed because the area marked by the square box (the area where the protective film was not attached) appeared foggy. In addition, the gloss unit (GU60°) was found to be 80.

Referring to FIG. 19, when viewing a surface SEM image of the glass article manufactured according to Example 1, it is found that a plurality of crystal particles that are viewed as black dots appeared to be formed randomly.

Through this result, it was confirmed that the gloss unit of the glass article may be adjusted by adjusting the etching amount of the glass article. In addition, it was confirmed that the plurality of crystal particles may be formed on the surface through the crystallization process of the glass article.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A glass article comprising:
an amorphous glass layer having an amorphous phase; and
crystal particles dispersed in the amorphous glass layer and having a crystalline phase,
wherein some of the crystal particles protrude from a surface of the amorphous glass layer.

2. The glass article of claim 1,
wherein the amorphous glass layer include an upper surface, a lower surface facing the upper surface and a side surface connecting the upper surface and the lower surface, and the some of the crystal particles protrude from at least one of the upper surface, the lower surface, and the side surface of the amorphous glass layer.

3. The glass article of claim 2,
wherein the some of the crystal particles protrude from the upper surface and the side surface of the amorphous glass layer.

4. The glass article of claim 2,
wherein the some of the crystal particles protrude from the upper surface of the amorphous glass layer.

5. The glass article of claim 2,
wherein the some of the crystal particles do not protrude from the lower surface of the amorphous glass layer.

6. The glass article of claim 2,
wherein the upper surface of the amorphous glass layer include a first area and a second area surrounding the first area in plan view, and the some of the crystal particles protrude from the upper surface of the amorphous glass layer in the first area and not protrude from the upper surface of the amorphous glass layer in the second area.

7. The glass article of claim 6,
wherein a thickness of the first area of the amorphous glass layer is smaller than the thickness of the second area of the amorphous glass layer.

8. The glass article of claim 2,
wherein the upper surface of the amorphous glass layer include a first area and a second area surrounding the first area, and the some of the crystal particles protrude from the upper surface of the amorphous glass layer in the first area and in the second area.

9. The glass article of claim 8,
wherein a thickness of the first area of the amorphous glass layer is greater than a thickness of the second area of the amorphous glass layer.

10. The glass article of claim 1,
wherein a size of the crystal particle is 10 nm to 50 nm.

11. The glass article of claim 1,
wherein a crystallinity is 50% to 85%.

12. The glass article of claim 1,
wherein a height of the crystal particle protruding from the surface of the amorphous glass layer is 10 nm to 50 nm.

13. A glass article comprising:
an amorphous glass layer having an amorphous phase; and
crystal particles dispersed in the amorphous glass layer and having a crystalline phase,
wherein the amorphous glass layer comprises a surface including a first area and a second area surrounding the first area in plan view, and
some of the crystal particles protrude from the surface of the amorphous glass layer in the first area.

14. The glass article of claim 13,
wherein a thickness of the first area of the amorphous glass layer is smaller than a thickness of the second area of the amorphous glass layer.

15. The glass article of claim 13,
wherein the some of the some of the crystal particles protrude from the surface of the amorphous glass layer in the first area and the second area.

16. The glass article of claim 15,
wherein a thickness of the first area of the amorphous glass layer is greater than a thickness of the second area of the amorphous glass layer.

17. The glass article of claim 13,
wherein a size of the crystal particle is 10 nm to 50 nm.

18. The glass article of claim 13,
wherein a crystallinity is 50% to 85%.

19. The glass article of claim 13,
wherein a height of the crystal particle protruding from the surface of the amorphous glass layer is 10 nm to 50 nm.

20. An electronic device comprising:
a display panel; and
a cover window disposed on the display panel,
wherein the cover window comprises:
an amorphous glass layer having an amorphous phase; and
crystal particles dispersed in the amorphous glass layer and having a crystalline phase,
wherein some of the crystal particles protrude from a surface of the amorphous glass layer.
